(19) United States
(12) Patent Application Publication
(10) Pub. No.: US 2009/0014926 A1
(43) Pub. Date: Jan. 15, 2009

(54) Method of constructing a hollow fiber reinforced structure

(75) Inventor: Bonnie D. Marini, Oviedo, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/825,691

(22) Filed: Jul. 9, 2007

(51) Int. Cl. C04B 35/76

(52) U.S. Cl. 264/635; 264/640

(57) ABSTRACT

A method of constructing a hollow fiber reinforced structure is disclosed. A spindle structure is provided for defining a preform shape. A resin binder or matrix is applied to a fiber material and the fiber material is placed around the spindle structure to create a hollow preform having a shape defined by the spindle structure. The preform structure is reshaped into a desired shape defined by the interior surface of a hollow mold and the exterior surface of an expandable insert structure. The reshaped preform structure is further conditioned to create a finished part. A hollow filament wound ceramic matrix composite airfoil suitable for use in a gas turbine engine may be constructed using the disclosed method.

### FIELD OF THE INVENTION

The present invention relates to a method of constructing a hollow fiber reinforced structure and, more specifically, relates to a method of forming a fiber reinforced ceramic matrix composite structure having a complex shape, such as an airfoil for use in a gas turbine engine.

### BACKGROUND OF THE INVENTION

Certain ceramics are attractive materials for use in structures that must be light weight yet maintain high strength at high operating temperatures. In particular, the airfoils of blades and vanes used in gas turbine engines must withstand exposure to hot combustion gasses under high pressure while also minimizing the airfoil weight to operating efficiencies. Moreover, such airfoils generally have complex geometric shapes, typically requiring a substantially convex suction side surface and a substantially concave pressure side surface. Monolithic ceramics, though readily formable into complex shapes, are brittle, and may not meet reliability requirements in such demanding applications without reinforcement.

It is known that ceramic materials may be reinforced by introducing fibers into the material during the production process. The fibers add strength to the structure resulting in a less brittle part. Various methods are known to produce a fiber reinforced part. For example, fibers may be woven into a fabric, multiple plies of fabric may be stacked to a desired thickness and the layered fiber mat formed into a desired shape in a mold creating a preform. The ceramic material may be introduced to the fabric before or after lay-up by various methods including chemical vapor infiltration, directed metal oxidation or by sol-gel processes. Subsequently, the preform is sintered to form a shaped ceramic matrix composite structure, hereinafter referred to as a CMC structure.

U. S. Pat. No. 6,660,115 B2 to Butler, et al. discloses a method of manufacturing a fiber reinforced CMC structure by vacuum impregnating a layered stack of fiber laminates with a slurry of ceramic sol, filler particles and a solvent. Because the laminates are impregnated in a vacuum, this method is suitable for forming structures having geometrically complex exterior shapes, such as an airfoil, by performing the vacuum impregnation process within a shaped hollow mold.

It is also known to produce a sol-gel CMC structure by filament winding. One such filament winding method comprises passing each fiber through a solution of ceramic material, winding the impregnated fiber on a mandrel of the desired shape, converting the sol to a gel and heating to convert the gel to a ceramic matrix.

Another method of constructing a filament wound CMC structure is called fiber placement. In this method, a moving head lays fabric on a complex geometry while simultaneously curing the product, allowing for stable placement. The fiber placement method is generally limited to materials and structures that may be sequentially cured, such as thermoplastics.

There continues to be a need for an efficient method of forming CMC structures having complex geometries and, in particular, for a method of forming an airfoil or similar shaped part for use in a turbine engine.

### SUMMARY OF THE INVENTION

In accordance with one aspect of the invention, a method of constructing a hollow fiber reinforced structure is provided. The method comprises providing a spindle structure for defining a preform structure, providing a fiber structure comprising a fiber material and a matrix, and placing the fiber structure around the spindle structure to create a preform structure having an interior volume. The preform structure is located within a mold having an interior surface, and an insert structure is moved within the interior volume of the preform structure. The insert structure has an exterior surface and is expandable in at least one direction. The preform structure is reshaped into a predetermined shape defined by the interior surface of the mold and the exterior surface of the insert structure to create a reshaped preform structure, and the reshaped preform structure is then conditioned, creating a finished hollow fiber reinforced structure.

In accordance with another aspect of the invention, a method of constructing a hollow fiber reinforced airfoil is provided, where the airfoil had an exterior surface including a substantially convex suction side surface and a substantially concave pressure side surface. The method comprises providing a spindle structure for defining a preform structure, providing a fiber structure comprising a fiber material and a matrix, and placing the fiber structure around the spindle structure to create a preform structure having an interior volume. The preform structure is located within a mold having an interior surface defining a substantially convex interior surface for defining the substantially concave pressure surface and a substantially concave interior surface for defining the substantially convex suction side surface. An insert structure is moved within the interior volume of the preform structure. The insert has an exterior surface and is expandable in at least one direction. The preform structure is reshaped into a predetermined airfoil shape defined by the interior surface of the mold and the exterior surface of the insert structure to define a reshaped preform structure, and the reshaped preform structure is then conditioned, creating a finished fiber reinforced airfoil.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a diagrammatic perspective view of a spindle structure illustrating first and second spools with a partial fiber structure;

FIG. 2 is a perspective view of the spindle structure of FIG. 1 illustrating a preform structure and an insert structure partially inserted within the preform structure;

FIG. 3 is a plan view illustrating the hollow preform structure within a mold and showing an insert structure in a non-expanded state within the interior volume of the preform structure;

FIG. 4 is a plan view similar to FIG. 3 showing the insert structure in an expanded state;

FIG. 5 is a perspective view illustrating a reshaped preform structure within the mold; and

FIG. 6 is a flow diagram illustrating the steps of the present invention.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

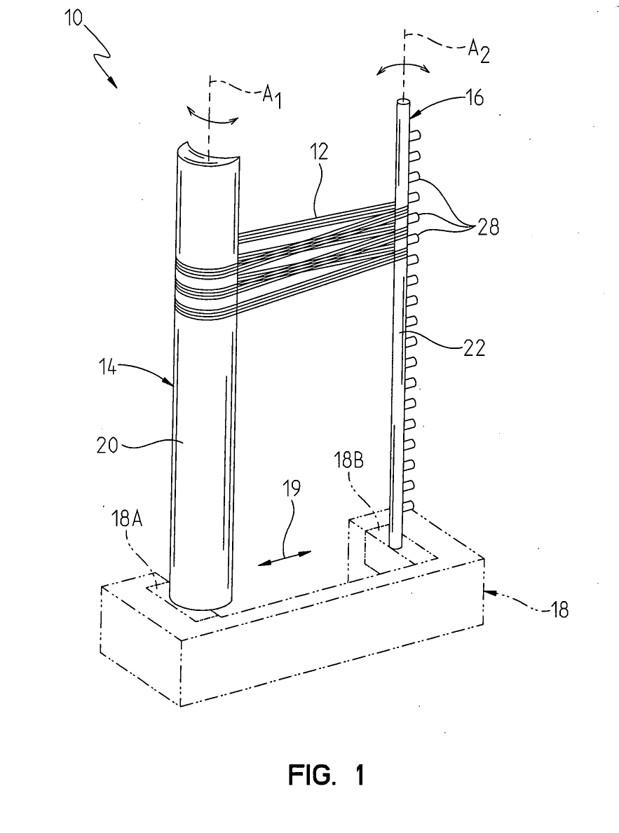

Referring initially to FIG. 1, the process and apparatus of the present invention is illustrated with reference to a spindle structure 10 including a first elongated spool 14, and a substantially smaller second elongated spool 16 located in spaced relation to the first spool 14 and extending substantially parallel to the first spool 14. A support structure for supporting the first and second spools 14, 16 is generally illustrated diagrammatically and is identified by reference numeral 18. The support structure 18 may comprise a first portion 18a supporting the first spool 14 for rotation about a first spool axis A₁, and may comprise a second portion 18b supporting the second spool 16 for rotation about a second axis A₂. In addition, one or both of the first and second support portions 18a, 18b may be actuated to displace the first and second spools 14, 16 longitudinally in a direction generally perpendicular to the axes A₁, A₂, such as to translate the spools 14, 16 toward and away from each other, as indicated by arrow 19.

In accordance with the principles of the present invention, a preform structure is formed by placement of a fiber material about the spools 14, 16. As seen in FIG. 1, a portion of a fiber structure has been formed extending around exterior surfaces 20, 22 of the spools 14, 16, respectively, and is illustrated by placement of a fiber structure comprising a plurality of wraps of a fiber material or tow 12 comprising one or more elongated strands of material. As is known in the art, a solution, such as a resin binder or matrix, for example a ceramic matrix slurry, may be applied to the tow 12 to prepare the tow 12 for the process of wrapping about the spools 14, 16, where the solution facilitates adherence of the fibers of the tow 12 to one another during the wrapping operation, and facilitating formation of the preform structure created around the spools 14,16. Alternatively, the tow 12 may comprise a pre-impregnated fiber or fibers, i.e., a prepreg that comprises a fiber that is pre-impregnated with a resin or matrix in a production process separate from the presently described process for forming the tow 12 on the spindle structure 10.

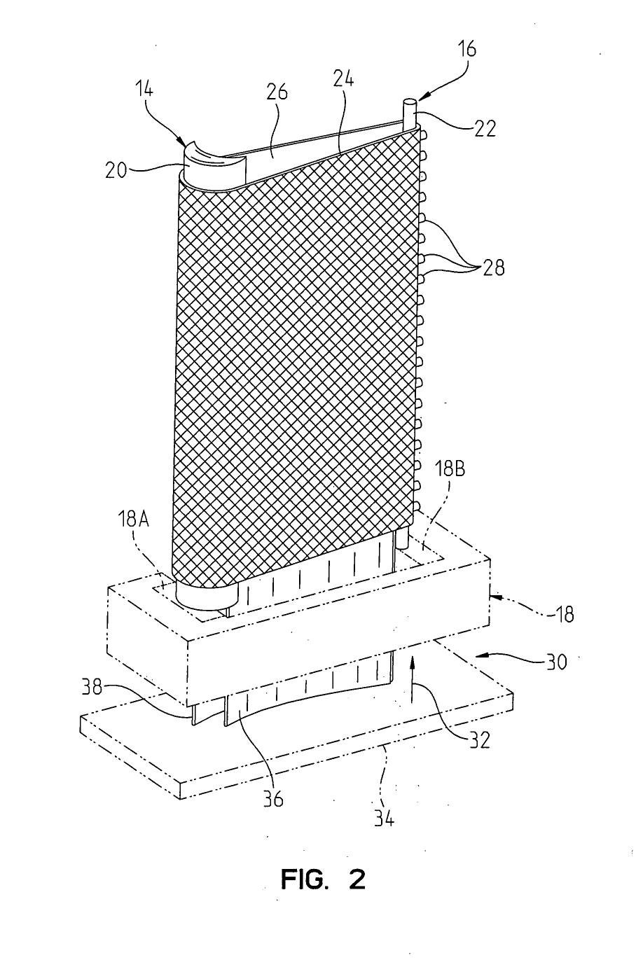

Referring to FIG. 2, a preform structure 24 is illustrated diagrammatically as being formed around the spools 14, 16 by a predetermined thickness of the fabric structure defined by the wound tow 12. Accordingly, the shape of the preform structure 24 is substantially determined by the configuration of the spindle structure 10, and in particular by the exterior surfaces 20, 22 of the first and second spools 14, 16, as well as the position and orientation of the spools 14, 16 relative to one another.

For the purposes of the present description, the preform structure 24 defined by the spools 14, 16 comprises a preform for constructing an airfoil, such as an airfoil preform for forming a turbine vane or blade. In this configuration of the preform structure 24, the exterior surface 20 of the first spool 14 defines an interior contour for a leading edge of the airfoil preform. Similarly, the exterior surface 22 of the second spool 16 defines an interior contour for a trailing edge of the airfoil preform. An interior volume defined by an elongated hollow space 26 extends longitudinally between the first and second spools 14, 16, such that the preform structure 24 comprises a hollow structure. The hollow space 26 may form a cavity within the airfoil for conducting a cooling fluid and, in the final form of the airfoil, a structure (not shown) may be provided in the hollow space 26 to define multiple cooling passages conducting cooling fluid in a predetermined pattern for obtaining a desired cooling effect. It should be noted that the second spool 16 may be provided with a plurality of pins 28 extending rearwardly from the exterior surface 22, as is illustrated only in FIGS. 1 and 2, for defining trailing edge cooling holes in the final airfoil shape for conducting a cooling fluid from the interior of the airfoil to an exterior area of the airfoil for cooling of the airfoil. That is, the pins 28 define a structure around which the tow 12 may be placed as the preform structure 24 is formed to the desired thickness. The pins 28 are optional and are disclosed solely for illustrative purposes, and it should be understood that the presence of the pins 28 is not required to achieve the object of the present invention discussed herein.

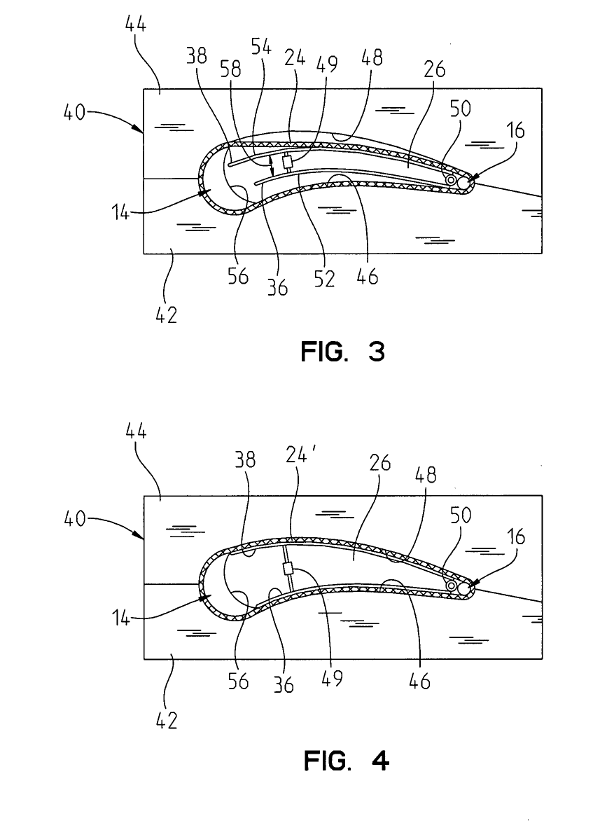

FIG. 2 further illustrates movement of an insert structure 30 within the hollow space 26 defined in the preform structure 24, and in particular illustrates movement of the insert structure 30 in an insertion direction, as depicted by arrow 32. The insert structure 30 comprises a support member, illustrated diagrammatically at 34, and first and second forming members 36, 38 mounted on the support member 34. The support structure 34 may be provided to support the forming members 36, 38 for movement between a retracted position (FIG. 3) and an expanded position (FIG. 4) and for movement into and out of the interior area of the preform structure 24 defined by the hollow space 26. The forming members of the insert structure 30 may initially be configured in the retracted position when the preform structure 24 is formed about the spindle structure 10, which configuration may be provided to facilitate positioning of the insert structure 24 in association with the hollow space 26 of the preform structure 24 as it is inserted in the direction 32.

It should be noted that upon completion of placement of the fabric structure about spools 14 and 16, the preform structure 24 is configured in a shape that conforms to the shape of the spindle structure 10, and the ceramic matrix slurry coated or prepreg fabric structure remains in a substantially non-rigid, i.e., substantially pliable, state. For the purposes of the illustrated embodiment, it should be understood that a typical airfoil has a substantially convex suction side surface and a substantially concave pressure side surface. After wrapping on spindle structure 10, the preform structure 24 remains non-rigid and has substantially linear sides defined by the linear distance between spools 14 and 16, as illustrated in FIG. 2. A mold 40 cooperates with the insert structure 30 to reshape the preform structure 24 into a desired airfoil shape defined by the shape of interior surfaces 46, 48 formed in respective first and second mold halves 42, 44 of the mold 40 and by the outer surfaces 52, 54 of the forming members 36, 38 of insert structure 30. This is most easily seen in FIG. 4 where insert structure 30 is shown fully expanded to conform the preform structure 24 to the inside surfaces 46, 48 of the mold 40, defining a reshaped structure 24′.

Referring to FIGS. 3 and 4, substantially concurrently with the insert structure 30 moving Within the hollow space 26 of the preform structure 24, the first mold half 42 and second mold half 44 may be actuated to move into surrounding relation around the preform structure 24. To form the airfoil shape illustrated in the presently described embodiment, the interior surface 46 of the first mold half 42 comprises a concave surface of the final airfoil shape, and the interior surface 48 of the second mold half 44 comprises a convex surface of the final airfoil shape. The first and second mold halves 42, 44 may be supported by appropriate apparatus (not shown) for moving toward each other to reshape the preform structure 24, providing surfaces 46, 48 substantially defining the final outer shape of an airfoil into which the exterior of the preform structure 24 may be reshaped.

With the preform structure 24 surrounded by the mold 40 and the insert structure 30 located within the hollow space 26, one or both of the forming members 36, 38 may be actuated, such as by an actuator illustrated diagrammatically at 49, to pivot about a pivot location 50 located adjacent the second spool 16. The first spool 14 includes an interior surface 56 configured to accommodate movement of the end(s) of one or both of the forming members 36, 38.

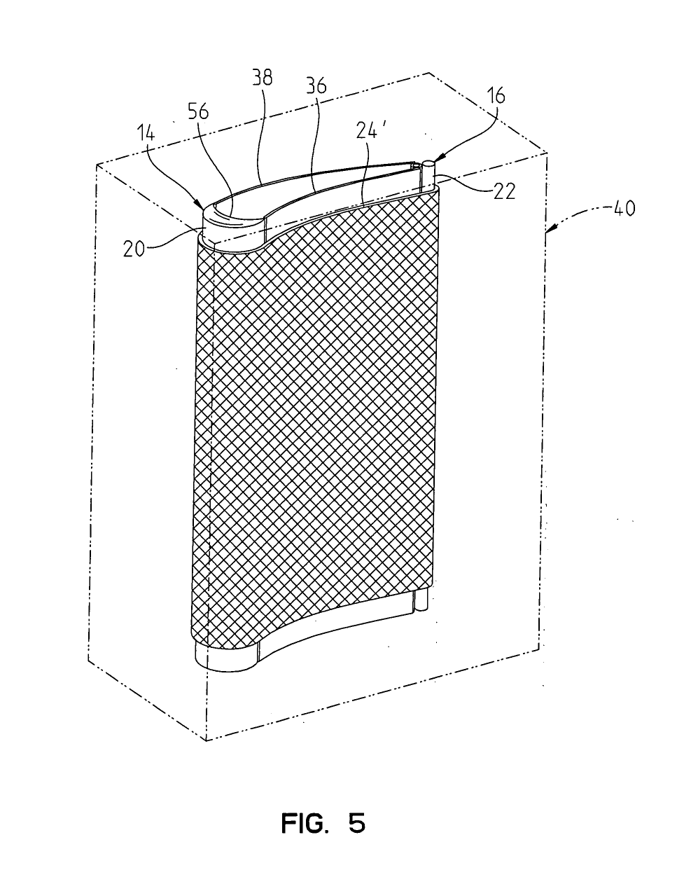

The preform structure 24 is engaged by the outer surfaces 52, 54 of the respective forming members 36, 38, as the forming members 36, 38 move outwardly in the direction 58, to reshape the preform structure 24 to the configuration of the reshaped structure 24′, as illustrated in FIGS. 4 and 5. The reshaped structure 24′ may be compressed with a predetermined pressure between the forming members 36, 38 and the mold halves 42, 44 to conform to the shape substantially defined by the interior surfaces 46, 48 of the mold halves 42, 44. In addition, the first and second spools 14, 16 cooperate with the interior surfaces of the mold 40 to define the shape of leading and trailing edges of the airfoil defined by the reshaped structure 24′. Accordingly, the exterior surfaces 20, 22 of first and second spools 14, 16 are contoured to cooperate with the insert structure 30 such that substantially all of interior surface of the preform structure 24 is supported during the reshaping process.

It should be understood that the present invention is not limited to a particular actuation mechanism for the forming members 36, 38 and that any actuator, including one or more actuators associated with the support structure 34 of the insert structure 30 may be provided. In addition, although the insert structure 30 is expandable in a single direction in the illustrated embodiment, other appropriate structures, including inflatable bladders or equivalent mechanisms may be provided that may be expanded in one or more directions and that perform the function of pressing the preform structure 24 outwardly into engagement with the interior surfaces 46, 48 of the mold 40.

It should be noted that in order to reshape preform structure 24 into an airfoil shape, it may be necessary for either or both of first and second spools 14 and 16 to rotate about axes A₁ and A₂ (FIG. 1), respectively, before or during outward movement of the forming members 36, 38, such as by actuation of the first and second portions 18a, 18b of the support structure 18. Further, it may be necessary to actuate the first and second portions 18a, 18b to translate the spools 14, 16 in the direction 19 during or in combination with rotation of the spools 14, 16. The rotation and translation of the spools 14, 16 may be provided to accommodate differences between the length of the sides of the preform structure 24 extending between the spools 14, 16 and the length of the surfaces 46, 48 of the mold halves 42, 44 as the reshaped structure 24′ is formed. Thus, one or both of spools 14 and 16 may be rotated about axes A₁ and A₂ as mold halves 38 and 40 are closed about spindle structure 10 with preform structure thereon. Additionally, one or both of spools 14, 16 may be translated toward the other spool in direction 19 to allow the preform structure 24 to conform to the interior shape of the mold halves 42 and 44.

The preform structure 24 may comprise a ceramic matrix composite material (CMC), where the ceramic matrix composite material may be any fiber reinforced ceramic matrix material or other appropriate material. The fibers and matrix material surrounding the fibers, i.e., the tow 12, may be oxide ceramics or non-oxide ceramics, or any combination thereof. The ceramic matrix fibers may combine a matrix material with a reinforcing phase of a different composition, such as, but not limited to, mulite/silica, or of the same composition, such as, but not limited to, alumina/alumina or silicon carbide/silicon carbide. The ceramic matrix fibers may also be reinforced with plies of adjacent layers being directionally oriented to obtain the desired strength. In at least one embodiment, the preform structure may be formed from A-N720, which is available from COI Ceramics, San Diego, Calif., with mulite-alumina reinforcing fibers in an alumina matrix. The mulite-alumina reinforcing fibers may comprise materials such as are commercially available, for example, from 3M Company under the trade designations NEXTEL 720 or NEXTEL 610.

Subsequent to the step of reshaping the preform structure 24 into a desired shape, i.e., the reshaped structure 24′, the reshaped structure 24′ may be subjected to a conditioning process including one or more steps to form a substantially rigid final structure. In particular, immediately after the reshaping process, the reshaped preform 24′ comprises a non-rigid or compliant structure and further processing is applied to rigidify the structure 24′ and/or to add additional material to the final structure. For example, the reshaped structure 24′ may initially be subjected to a drying process at a moderate temperature of approximately 150 degrees C. to 300 degrees C. while it is still within the mold 40 to get the reshaped structure 24′ to a green state. The drying step may be performed with or without the insert structure 30 in place. However, in the event that cooling holes are defined in the trailing edge of the preform structure 24, the pins 28 should remain in place at least through the drying step. In a subsequent step, the green state reshaped structure 24′ is removed from the mold 40 and is fired in a kiln at a high temperature, such as approximately 1250 degrees C. to 1350 degrees C. to sinter the part to a high bisque state. The resulting sintered part may then be machined as necessary or other operations may be performed to finish the part.

In addition to the above-noted steps, a coating or insulating layer may be provided to the sintered part to provide a hybrid ceramic structure, such as to further strengthen the part and/or to increase the temperature capability of the part. In particular, the sintered part may be provided with a coating that is cast onto appropriate places on the part within a mold. The part with the coating may then be subjected to a drying process and a firing process to produce a hybrid part at a final fired state. A description of a high temperature coating for providing an insulating hybrid oxide layer is disclosed in U.S. Pat. No. 6,733,907, which patent is incorporated herein by reference.

Though the illustrated and preferred embodiment shows how the steps of the present invention may be used to create a fiber reinforced ceramic matrix composite airfoil shape, it will be apparent to those skilled in the art that other embodiments of the invention having differently shaped spools, insert structures and molds may be used to create objects having different shapes. It is further anticipated that the present invention may be used to create structures from materials other than ceramics.

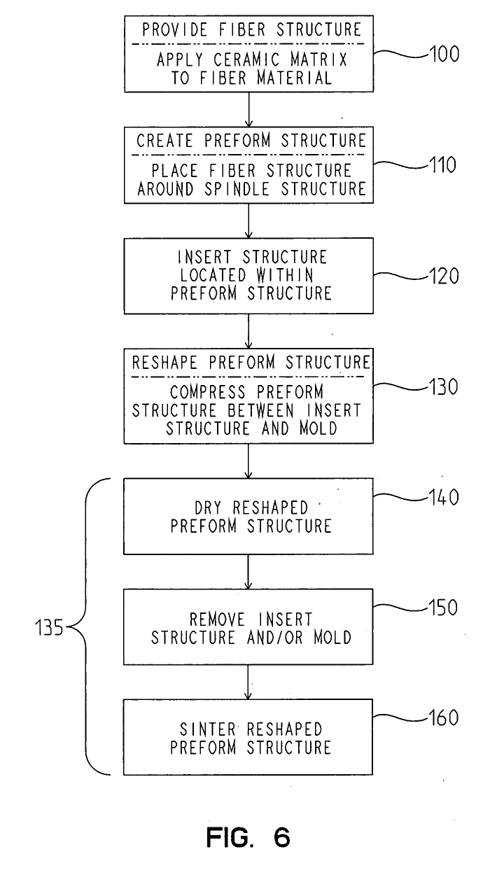

FIG. 6 is a flow diagram illustrating the steps of the present invention. In step 100 a fiber structure is provided and may comprise a fiber material having a matrix applied, such as a ceramic matrix slurry applied to a fiber material. As noted previously, the fiber structure may comprise a pre-impregnated material.

In step 110, a preform structure 24 is created by placing the fiber structure around a spindle structure 10, such as by winding the fiber tow 12 around the spindle structure 10. At the conclusion of step 110, the completed preform structure 24 is defined by a shape established by the spindle structure 10 but remains non-rigid until further processing.

In step 120, the insert structure 30 is defined as being located within the interior volume of the hollow preform structure 24. Although the illustrated embodiment shows the insert structure 30 being moved into the preform structure 24 after the process of placement of the material on the spindle structure 10, it is anticipated that the insert structure 30 may either be located within the spindle structure 10 during the placement step 110 or moved therein subsequently.

In step 130 the preform structure 24 is reshaped into a desired shape as defined by the spindle structure 10, the insert structure 30 and the mold 40, as previously described. Reshaping preform structure 24 with the mold halves 42, 44 and the insert structure 30 allows construction of structures having concave exterior surfaces by providing one or more convex interior surfaces on mold halves 42 or 44. A compressive pressure may be applied to compress the preform structure 24 against the interior surfaces 46 and 48 of mold halves 42 and 44, respectively, to complete the reshaping process and/or aid the drying process.

After the reshaping step 130, the preform structure 24 may be subjected to one or more conditioning steps 135. The conditioning steps 135 may comprise a drying step 140, a step 150 comprising removal of the insert structure 30 and/or the mold 40 and a step 160 of sintering the reshaped preform structure, such as by a firing process to form a final hardened part. In addition, as noted above further processing may be provided to the part, including machining and/or formation of a hybrid part through application of additional material.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of constructing a hollow fiber reinforced structure, the method comprising the steps of:
providing a spindle structure for defining a preform structure;
providing a fiber structure comprising a fiber material and a matrix;
placing said fiber structure around said spindle structure, creating said preform structure having an interior volume;
locating said preform structure within a mold, said mold having an interior surface;
moving an insert structure within said interior volume of said preform structure, said insert structure having an exterior surface, said insert structure being expandable in at least one direction;
reshaping said preform structure into a predetermined shape defined by said interior surface of said mold and said exterior surface of said insert structure to define a reshaped preform structure; and
conditioning said reshaped preform structure creating a finished hollow fiber reinforced structure.

2. The method of claim 1, wherein said matrix comprises a ceramic material applied to said fiber material.

3. The method of claim 2, wherein said fiber material comprises an elongated fiber tow or tape and said step of placing said fiber structure around said spindle structure further comprises winding said fiber material around said spindle structure to a desired thickness.

4. The method of claim 2, wherein said step of conditioning further comprises the steps of:
drying said reshaped preform structure to a predetermined dryness to define a green state reshaped structure;
removing said mold and said insert structure from said green state reshaped structure; and
sintering said green state reshaped structure creating a finished fiber reinforced ceramic matrix composite structure.

5. The method of claim 1, wherein said step of reshaping said preform structure further comprises applying a compressive pressure between said exterior surface of said insert structure and said interior surface of said mold.

6. The method of claim 4, wherein said mold has at least one substantially convex interior surface for defining a substantially concave exterior surface on said preform structure.

7. The method of claim 1, wherein said step of providing a spindle structure further comprises:
providing a first spool having an exterior surface for defining a first interior surface of said preform structure; and
providing a second spool having an exterior surface for defining a second interior surface of said preform structure, said first spool being spaced apart from said second spool and extending in a direction substantially parallel with said second spool.

8. The method of claim 7, wherein said step of reshaping said preform structure further comprises the steps of:
expanding said insert structure; and
moving at least one of said first spool and said second spool relative to the other of said spools, wherein said mold, said insert structure, said first spool and said second spool cooperate to reshape said preform structure into said reshaped preform structure.

9. The method of claim 6, wherein said first spool has a diameter substantially greater than a diameter of said second spool and said hollow fiber reinforced structure comprises an airfoil.

10. The method of claim 1, wherein said matrix comprises a ceramic material applied to said fiber material, said fiber material comprises an elongated fiber tow or tape, said step of placing said fiber structure around said spindle structure further comprises winding said fiber material around said spindle structure to a desired thickness, and said mold has at least one substantially convex interior surface for defining a substantially concave exterior surface on said preform structure.

11. A method of constructing a hollow fiber reinforced airfoil, the airfoil including an exterior surface having a substantially convex suction side surface and a substantially concave pressure side surface, the method comprising the steps of:
providing a spindle structure for defining a preform structure;
providing a fiber structure comprising a fiber material and a matrix;
placing said fiber structure around said spindle structure creating said preform structure having an interior volume;
locating said preform structure within a mold, said mold having an interior surface having a substantially convex interior surface for defining said substantially concave pressure side surface and a substantially concave interior surface for defining said substantially convex suction side surface;
moving an insert structure within said interior volume of said preform structure, said insert structure having an exterior surface, wherein said insert structure is expandable in at least one direction;
reshaping said preform structure into a predetermined airfoil shape defined by said interior surface of said mold and said exterior surface of said insert structure to define a reshaped preform structure; and
conditioning said reshaped preform structure creating a finished hollow fiber reinforced airfoil.

12. The method of claim 11, wherein said matrix comprises a ceramic material applied to said fiber material.

13. The method of claim 12, wherein said fiber material comprises an elongated fiber tow or tape and said step of placing said fiber structure around said spindle structure further comprises winding said fiber material around said spindle structure to a desired thickness.

14. The method of claim 13, wherein said step of conditioning further comprises the steps of:
drying said reshaped preform structure to a predetermined dryness to define a green state reshaped structure;
removing said mold and said insert structure from said green state reshaped structure; and
sintering said green state reshaped structure creating a finished hollow fiber reinforced ceramic matrix composite airfoil.

15. The method of claim 11, wherein said step of reshaping said preform structure further comprises applying a compressive pressure between said exterior surface of said insert structure and said interior surface of said mold.

16. The method of claim 11, wherein said step of providing a spindle structure further comprises the steps of:
providing a first spool having an exterior surface for defining a leading interior surface of said preform structure; and
providing a second spool having an exterior surface for defining a trailing interior surface of said preform structure, said first spool having a diameter substantially larger than a diameter of said second spool and said first spool being spaced apart from said second spool and extending in a direction substantially parallel with said second spool.

17. The method of claim 16, wherein said step of reshaping said preform structure further comprises the steps of:
expanding said insert structure; and
moving at least one of said first spool and said second spool relative to the other of said spools, wherein said mold, said insert structure, said first spool and said second spool cooperate to reshape said preform structure into said reshaped preform structure having a leading interior surface defined by said exterior surface of said first spool and a trailing interior surface defined by said exterior surface of said second spool.

18. The method of claim 17, further comprising the step of providing a plurality of pins on said spindle structure, said pins defining a plurality of apertures in said preform structure for creating a plurality of holes in said predetermined airfoil shape said holes extending from said interior volume of said preform structure to said exterior surface of said predetermined airfoil shape.

19. The method of claim 18, wherein said plurality of pins are positioned upon said exterior surface of said second spool such that said plurality of apertures are created in said trailing interior surface of said predetermined airfoil shape.

20. The method of claim 14, further comprising the step of bonding an insulating layer to said fiber reinforced ceramic matrix composite airfoil creating a hybrid ceramic matrix composite airfoil.
